(19) United States
(12) Patent Application Publication
(10) Pub. No.: US 2024/0414285 A1
(43) Pub. Date: Dec. 12, 2024

(54) NETWORK RELAY

(71) Applicant: Monitoreal Limited, Larnaca (CY)

(72) Inventor: Aydar YAKUPOV, Pyla (CY)

(73) Assignee: Monitoreal Limited, Larnaca (CY)

(21) Appl. No.: 18/741,470

(22) Filed: Jun. 12, 2024

Related U.S. Application Data
(60) Provisional application No. 63/507,632, filed on Jun. 12, 2023.

(51) Int. Cl. H04N 7/18; G06V 20/40; G08B 21/04; H04L 12/28

(52) U.S. Cl. CPC H04N 7/18; G06V 20/44; G08B 21/04; H04L 12/2816; H04L 12/2832; G06V 2201/07

(57) ABSTRACT

Embodiments are directed to a relay configured to operate a plurality of electric appliances in conjunction with smart camera device that performs object detection.

### CROSS REFERENCE TO RELATED APPLICATIONS

This application is a U.S. patent application claiming priority U.S. Provisional Patent Application No. 63/507,632, filed on Jun. 12, 2023, the entirety of each of which is incorporated herein by reference.

### BACKGROUND

“Smart” cameras such as Netgear's Arlo, Google's Nest, or Amazon's “Deep Lens” and “Ring” share the same disadvantages: they require the consumer to use a public cloud service for storage and processing, which raises serious privacy and security concerns. Additionally, these solutions require the consumer to purchase special purpose “smart” cameras specially configured to work with their respective proprietary interfaces or cloud-based platforms.

Further, such platforms require bundling a camera with a cloud account for data processing. For autonomous systems that need to function without a reliable connection to the Internet, significantly more powerful (50-100×) hardware is utilized by such platforms.

Smart camera and video camera platforms similarly require networking with “smart home” conventional cloud based Internet of Things (IoT) networks such as those mentioned above to control building devices and appliances, including security devices and security based protocols. As such, it becomes increasingly more difficult to have robust security systems that have all the advantages of IoT enabled control and operation while remaining independent and privately secured from cloud-based platforms.

### SUMMARY

The following briefly describes a basic understanding of some aspects of the embodiments. Its purpose is merely to present some concepts in a simplified form as a prelude to the more detailed description that is presented later.

In an implementation, an Input Output (I/O) Network Relay is configured to interface with a Video Security Assistant (VSA), also called a Video Security Hub (VSH), module to enhance the VSH system capabilities. The I/O Network relay is configured to allow a user to integrate a VSH with any electrical devices to trigger detection-driven action such as turn on the lights, switch on alarm, open/close gates, lock/unlock doors, and so on The I/O Network Relay can also interface and integrate with other security or perimeter protection systems, such as various alarm systems, so that a user can arm or disarm a VSH as a proactive video alarm from a conventional alarm panel. The I/O Network Relay is configured to transform conventional household, office, or workplace appliances into a unified, complex security system that can both warn an owner of an intrusion as well as actively deter intruders and compel them to retreat before they even approach a perimeter protected by the alarm itself.

Inputs of the relay are designed and configured to be universal so that they can be readily and easily integrated with virtually any alarm panel.

A plurality of outputs of the relay—3 for example—have a voltage from 90V to 240.

In an implementation, an Audio Module allows users to upload and play a sound file via a connected wireless speaker (e.g. Bluetooth™) based on the rules they set. The rules can be set to be triggered when a specified object has been detected immediately or with delay.

The I/O Relay features can be combined to create a sequence of events that will in most cases create an impression of the owners being present inside the house to deter burglars from breaking in.

Unlike conventional “smart” relays, the I/O Relay can be configured to operate without reliance on a on a cloud service. The I/O relay can be configured to operate locally in an autonomous system with the option for manual control locally or remotely.

In an embodiment, there is provided a device for analyzing video streams comprising: a computer, including: a transceiver for communicating over a network; a memory for storing at least instructions; a relay for controlling a plurality of devices, a processor device configured for edge processing one or more of video streams and to perform object detection on a local network independent of a cloud architecture. In an embodiment, the processor can be a microcomputer processor. In an embodiment, the device of can further comprise a rules engine and can be operatively connected to an interface configured to allow a user to set one or more rules for object detection.

In an embodiment, the device of can further comprise a machine learning engine and a training database comprising training data from the one or more camera feeds, wherein the machine learning engine is configured to tune the scene detection engine, the object detection engine, or both.

In an embodiment, there is provided a method for processing a video stream, the method being performed by a computer system that comprises a relay and a processor configured for edge processing one or more of video streams and to perform object detection on a local network independent of a cloud architecture. In an embodiment, the device can comprise a rules engine being operatively connected to an interface configured to allow a user to set one or more rules for object detection. In an embodiment, the method can comprise device being operatively connected to a rules engine and comprising an interface configured to allow a user to define an inclusion zone and an exclusion zone for object detection. The method can further comprise the computer comprising an interface configured to allow a user to set one or more rules for object detection. The method can further comprise the computer comprising: a machine learning engine; and a training database comprising training data from the one or more camera feeds; wherein the method further comprises tuning the scene detection engine, the object detection engine, or both with the machine learning engine. In an embodiment, the method can be executed by a microcomputer processor.

In an embodiment, the method can be executed with a computer comprising a rules engine and operatively connected to an interface configured to allow a user to set one or more rules for object detection. In an embodiment, the method can be executed with a computer comprising rules engine operatively connected to interface configured to allow a user to define an inclusion zone and an exclusion zone for object detection. In an embodiment, the method can be executed with a computer comprising a facial recognition algorithm, and the method can further comprise identifying and classifying objects identified by the facial recognition algorithm with the object detection engine.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIGS. 1A-1C is a system diagram of an environment in which at least one of the various embodiments can be implemented.

FIG. 2 is a logical architecture and flowchart of a device in accordance with at least one of the various embodiments.

FIG. 3 represents a logical architecture for a device in accordance with at least one of the various embodiments.

FIGS. 4A-4B show user interfaces in accordance with at least one of the various embodiments

FIGS. 5A-E show user interfaces in accordance with at least one of the various embodiments.

FIGS. 6A-6D show user interfaces in accordance with at least one of the various embodiments.

FIGS. 7A-7E show user interfaces in accordance with at least one of the various embodiments.

FIG. 8 shows a user interface in accordance with at least one of the various embodiments.

### DETAILED DESCRIPTION

Various embodiments now will be described more fully hereinafter with reference to the accompanying drawings, which form a part hereof, and which show, by way of illustration, specific embodiments by which the innovations described herein can be practiced. The embodiments can, however, be embodied in many different forms and should not be construed as limited to the embodiments set forth herein. Rather, these embodiments are provided so that this disclosure will be thorough and complete, and will fully convey the scope of the embodiments to those skilled in the art. Among other things, the various embodiments can be methods, systems, media, or devices. Accordingly, the various embodiments can take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in an embodiment” as used herein does not necessarily refer to the same embodiment, though it can. Furthermore, the phrase “in another embodiment” as used herein does not necessarily refer to a different embodiment, although it can. Thus, as described below, various embodiments can be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a” “an” and “the” include plural references. The meaning of “in” includes “in” and “on.”

The following briefly describes embodiments in order to provide a basic understanding of some aspects of the innovations described herein. This brief description is not intended as an extensive overview. It is not intended to identify key or critical elements, or to delineate or otherwise narrow the scope. Its purpose is merely to present some concepts in a simplified form as a prelude to the more detailed description that is presented later.

### Illustrative Operating Environment

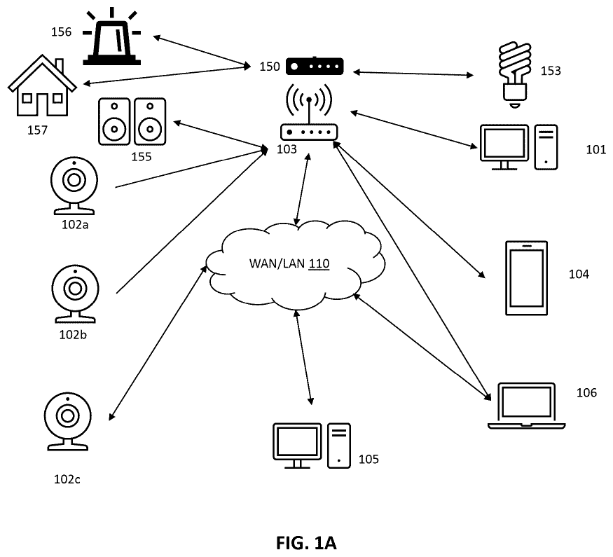

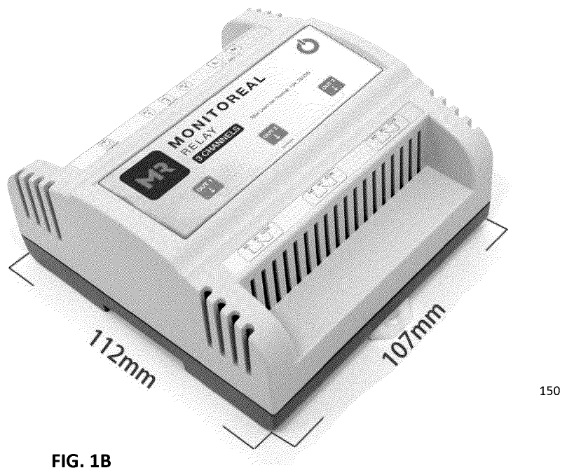

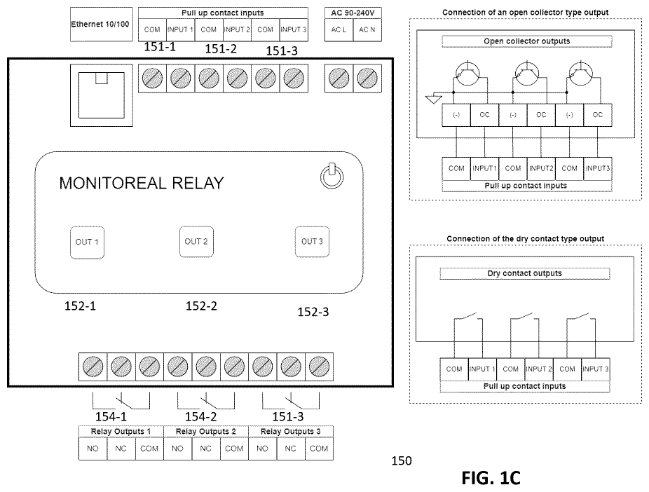

FIG. 1A shows components of one embodiment of an environment in which embodiments of the innovations described herein can be practiced. Not all of the components are required to practice the innovations, and variations in the arrangement and type of the components can be made without departing from the spirit or scope of the innovations.

In at least one of the various embodiments, the system 100 is configured to operate with a simple microcomputer device 101. For example, in an embodiment, the system can include microcomputer built on or more circuit boards, with microprocessor(s), memory, input/output (I/O), a power adapter, an optional LED Matrix (for data output), and a plastic enclosure with one or more cooling fans. An exemplary microcomputer device can be, for example, a Raspberry Pi 3B, or a similar device. The device connects to a user's network 103 wirelessly (WiFi) or via an Ethernet cable. It can then discover cameras 102a, 102b, 102c connected to the same network 103, and allow the user to configure rules for monitoring by each camera 102a, 102b, 102c. The system can be configured to connect to and monitor local video feeds as well as remote video feeds provided over a wide area network or the Internet. The system can be configured to work with a conventional IP camera, for example, and IP camera that is configured to be compatible with and operate according to ONVIF standards (Open Network Video Interface Forum Inc.).

Once an initial setup is complete, the device 101 is configured to continuously monitor video feeds from all selected cameras 102a, 102b, 102c, identify objects and events in their video streams, and alert the user in real time, for example via a messenger module, for example a chat bot 111, based on predefined rules. An example of a rule would be “if you see a dog during the day-ignore it, but if you see a dog between 10 pm and 6 am—send me an alert”. Additionally, the device 101 can monitor itself to identify performance bottlenecks and fine-tune the algorithm. If a hardware (or environment problem is detected (e.g. the device is getting too hot), the device can be configured to notify the user automatically.

The device has a mechanism for updating its own software (e.g. when a new algorithm is released).

The device is designed to connect to an existing network 103 (via WiFi or Ethernet) and automatically discover IP cameras 102a, 102b, 102c connected to the same network. The system is configured with an interface whereby the user can confirm which cameras they want to monitor, and what objects or events interest them.

Exemplary advantageous features include:

A one-to-many architecture: one “box” supporting one or more existing cameras (e.g. 3-5 cameras per box or 4-12 cameras per box).

A selective, cascading algorithm that first performs a light operation on the video frame to determine whether a deeper (more CPU-intensive) analysis is needed.

A self-tuning event processing queue configured to intelligently allocates resources to cameras, based on the amount of action/complexity present in their video frames.

An interactive “chat” interface-where the user can communicate with the device via messenger or chat bot.

Exemplary advantages of the system and device include:

Complete privacy—the system can be configured such that users' video streams need never leave their local network.

The system can operate autonomously, without requiring a cloud architecture to support it.

Low energy use. For example, in an embodiment, a system configured device performs on average at 5 Watts per device on average, vs. hundreds of Watts for alternatives Small footprint—the device is the size of a typical IP camera.

Low hardware cost.

Ease of maintenance.

The device can download new detection algorithms as they become them available, gaining new capabilities.

The system is configured to enable advanced Artificial Intelligence operations such as visual object detection, which conventionally requires expensive high-performance hardware, on low-powered edge devices without the need for a cloud architecture. In an embodiment, local devices are able to operate autonomously and make decisions locally, without sending private information to the cloud for processing.

In an implementation, the device 101 is configured to interface with an I/O Network Relay 150. FIGS. 1B-1C show an exemplary I/O Network Relay. The I/O Network Relay 150 comprises a plurality of electromagnetic relays 152n. The electromagnetic relays 152n are configured as independent electromagnetic relays 152n, where each electromagnetic relay 152n can independently switch an electrical load.

Each of the electromagnetic relays 152n can be controlled remotely by a command from the device 101, for example, a security user interface. In an implementation, the I/O Network Relay 150 can be configured to operate on an AC 90˜240 V. The I/O Network Relay 150 can be configured with Ethernet and/or WiFi connection for communication with a security assistant module of the device 101 interface. Remote control and monitoring of the I/O Network Relay 150 can also be carried out by the security assistant module. The I/O Network Relay 150 also has a plurality of inputs 151n and outputs 154n to enable integrations with building security devices 156 and utilities such as alarm control panels, and electrical appliances 157, for example lighting 153, speakers 155, smart devices, and so on. In an exemplary advantage, the I/O Network Relay 150 can be configured to operate in local integrations independent of a cloud architecture.

FIG. 1B shows an exemplary implementation of a I/O Network Relay 150. As shown in FIG. 1B, in an implementation, the I/O Network Relay 150 can be of compact design, for example 107×112×58 mm and 220 g including a plastic with an enclosure protection rating of IP30 and an DIN-RAIL 35 mm (TS35/7.5 OR TS35/15) installation. The I/O Network Relay 150 can be powered by a supply voltage of 90-264 A with a power input of 4 W or less.

As shown in FIG. 1C, in an implementation, I/O Network Relay 150 comprises 3 independent electromagnetic relays 152-1, 152-2, 153-3 switching channels. The I/O Network Relay 150 can be configured for a maximum load on each channel for 8 A at 250 VAC, 6 A at 30 VDC, and 3 A at 40 VDC. The output 154-1, 154-2, 154-3 connectors for the electromagnetic relays 152n can include dry contacts (COM-NC/NO). A connector/wire cross section can be a screw terminal block/30˜16 AWG (0.05˜1.5 mm²). The I/O Network Relay 150 electromagnetic relays 152-1, 152-2, 153-3 include 3 independent inputs 151-1, 151-2, 151-3 including pull up contacts. The input 152-1, 152-2, 153-3 connectors for the electromagnetic relays 152n can include open connector dry contacts (COM-NC/NO). A connector/wire cross section can be a screw terminal block/30˜16 AWG (0.05˜1.5 mm²).

Controls can include 3 buttons for each channel control and with relay status indications. The I/O Network Relay 150 can be configured to allow a user to press and hold the OUT1 button to reset the Relay to the factory settings.

The I/O Network Relay 150 can be configured for wired and/or wireless connectivity. For example, the I/O Network Relay 150 can include 2.4 GHz 802.11 b/g/n (802.11n up to 150Mbps) wireless LAN and/or a 10/100 Mbit/s Ethernet network connector.

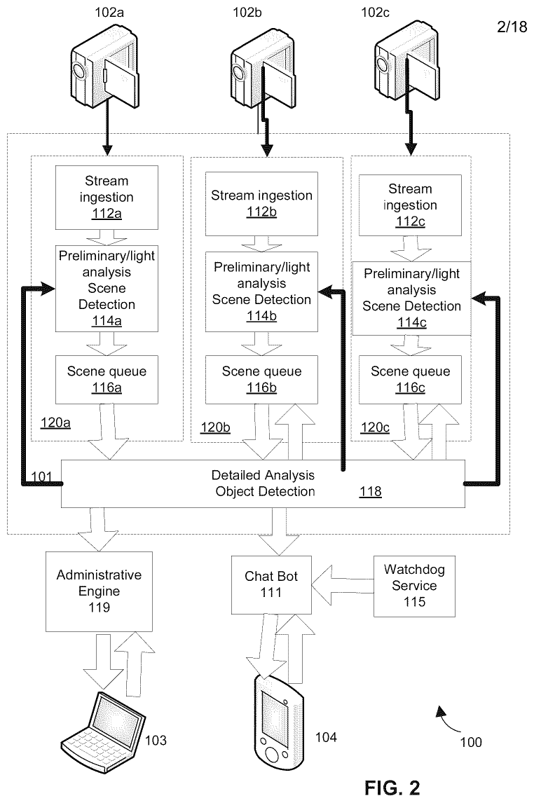

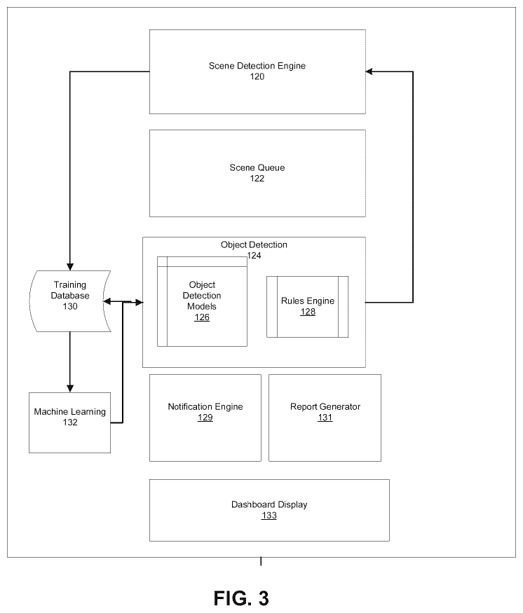

FIGS. 2-3 shows one embodiment of an environment and logical architecture and system flow in which embodiments of the innovations described herein can be practiced. In at least one of the various embodiments, described in conjunction with FIGS. 2-3, respectively, can be implemented by and/or executed on a single computer. However, embodiments are not so limited, and various combinations of network computers, client computers, virtual machines, or the like can be utilized.

In at least one of the various embodiments, event information can be stored in one or more data stores, for later processing and/or analysis. Likewise, in at least one of the various embodiments, camera stream information can be processed as it is determined or received. Also, stream information can be stored in data stores, such as databases, for use as, inter alia, a training database.

In an embodiment, the device 101 is configured to monitor individual streams from one or more cameras 102a, 102b, 102c. The system 100 is configured to process multiple video streams from each of the cameras 102a, 102b, 102c. To perform multi-stream monitoring, the device is configured to ingest and process each camera 102a, 102b, 102c stream individually using edge processing. As shown in FIG. 2, for purposes of simplification the illustration shows 3 cameras 102a, 102b, 102c, however the system can be configured to include any number of cameras permitted by the computational power of the device. For example, a system powered by a simple microprocessor device, for example a Raspberry Pi 4 equipped a neural compute module (such as Intel NCS2 or Google Coral), can initially handle up to 12 cameras and individual camera snapshots when configured as described herein. As will be appreciated, the system algorithms can be tuned to handle even more cameras based on computational power needed to process individual feeds, as some feeds can require or be determined to require less processing.

At block 112a, in at least one of the various embodiments, the device 101 is configured to ingest a video stream from an individual camera 102a. At block 114a, the device 101 includes a scene detection engine 120 configured to perform scene analysis. The scene detection engine 120 includes a lightweight algorithm or set of algorithms configured for a quick analysis to determine if the video scenes should be passed down for further, more computationally intensive analysis. A number of scene detection processes can be employed. For example, in an embodiment the device is configured to employ multiple processes of scene detection. One process includes computing a mean structural similarity index between two images, for example a current video frame against a previous video frame, for example as employed in scikit-image image processing in python. The exemplary algorithm is configured to perform image comparison and calculate a similarity frame score. If the similarity frame score is less than a scene threshold, at block 116a the system is configured to pass the frames to a scene queue 122 for further analysis. In an embodiment, the scene detection engine 120 can also configured to employ HSV (hue, saturation, value) to determine a color space difference between frames. The exemplary algorithm is configured to perform image comparison and calculate a scene threshold. If the scene threshold determines there is a new scene, at block 116a the system is configured to pass the frames to a scene queue 122 for further analysis.

The scene detection engines 120a, 120b, 120c are configured to run in parallel for each stream. The scene detection algorithms are lightweight, and configured to detect gross changes in scenes, which can identify simple movements without further analysis for image interpretation. Such scene detection can identify simple movements, for example, a person or animal running, and rules can be developed to correlate such movements and the need for identification without need for detailed analysis.

For example, once the device begins motion tracking of a detected object and knows an object is (e.g., a person) the device can track it without the need for further detailed analysis. In an embodiment, the device can be configured to perform tracking with the scene detection engine 120 and the preliminary analysis 114 after a detailed analysis 118. An exemplary algorithm for such detection includes, for example: As will be appreciated, once the system has identified an object via the detailed analysis 118, the system can then be configured to use the lightweight scene differential analysis to track the “known” object without having to continue to pass the frames to the object detection engine 124 for repeated analysis.

An exemplary advantage of preliminary processing each individual video stream using individual scene detection is that it allows bespoke processing of each stream, and thus the system can be configured to adjust the parameters for each stream, and hence, each field of view of the camera for that stream, to tailor the scene detection to the area monitored. Another exemplary advantage of preliminary processing each individual video stream using individual scene detection is that it preserves computational processing and memory resources of the device 101, as the lightweight scene detection engine can be selective about scenes it will save and pass on for further analysis.

For example, a system can be configured where one camera 102a is an outdoor camera at a main entrance of an office building, another camera is an indoor camera 102b, and a third camera 102c is a “backdoor” outside camera. The first outdoor main entrance camera 102a can be configured to ignore detection events during business hours. This camera 102a can also be tuned to set a scene threshold to ignore events triggered smaller scene differentials, for example as would be triggered by small animals. The backdoor camera 102b can be configured to ignore detection events between hours for routine deliveries, for example in the morning (e.g. 6:00 am-11:00 am) but can be set to detect events at other times when visitors would not be expected. The indoor camera 102b can also be configured to ignore detection events during work hours and has a scene threshold that detects any indoor movement at other times. The backdoor camera 102c could also be configured to set a color space analysis or scene threshold that ignores movements that are above a threshold that correlates to fast movement by larger objects, for example vehicles traveling on a road in the field of view of the camera.

As noted above, each video stream from each of the plurality of cameras 102a, 102b, 102c is individually analyzed by a scene detection engine 120 configured for that stream. If the scene detection engine 120 determines that a detected event triggers further analysis, at block 116a the device 101 then queues as series of scenes in the scene queue engine 122. The scene queue engine 122 then performs an analysis on the sequence of scenes to capture data and to do video content pre-processing, for example, to clean the data to remove noise. Sequence analysis can determine, for example, movement vectors in the scene sequence, for example, entry, movement in scene, and exit, and can continue to queue the stream while the triggering event is ongoing.

As each camera 102a, 102b, 102c performs scene detection 112a, 112b, 112c and queues scenes 116a, 116b, 116c triggered by the respective scene detection 112a, 112b, 112c, at block 118, each scene queue then sends the pre-processed video content to the object detection engine 124 for detailed analysis. The objection detection engine 124 is configured with a database of detection models 126 and a rules engine 128. In an embodiment, the device 101 can be configured to employ, for example an OpenCV Deep Neural Network (DNN) with pre-trained TensorFlow and Caffe models for detecting a pre-defined set of objects. An exemplary pre-defined set of objects can comprise, in a “background” class, a list of objects such as ‘aeroplane’, ‘bicycle’, ‘bird’, ‘boat’, ‘bottle’, ‘bus’, ‘car’, ‘cat’, ‘chair’, ‘cow’, ‘diningtable’, ‘dog’, ‘horse’, ‘motorbike’, ‘person’, ‘pottedplant’ ‘sheep’, ‘sofa’, ‘train’, ‘tvmonitor’. In an embodiment, an object detection engine 124 configured with a Tensorflow model set can include up to 90 different classes of objects. The object detection engine 124 can be configured to import these models from a provided pathway to the Tensorflow object detection models (e.g. at Github via the pathway <models/research/object_detection/data/mscoco_label_map.pbtxt>). As will be appreciated, other objection detection models 126 as known to ordinarily skilled artisans, including those available at object model repositories such as Github, IBM, Amazon, or can include proprietary models can be employed for an object detection engine.

In an embodiment, the system can be configured to natively support an Artificial Intelligence (AI) module 132, for example, a neural computational module. In an embodiment, an exemplary neural computation model can be provided by, for example, a low-power AI inference processor configured to run deep neural networks (DNNs) at high performance. The neural computational model can be configured as an add-on, which accelerates the device, making processing up to 10 times faster. The neural computational model can thereby unlock additional object detection and analysis capabilities, for example, more accurate, computing-intensive detection algorithms. An exemplary neural computational model can be provided by, for example, the Intel® Neural Compute Stick 2 (Intel® NCS 2), including Intel Movidius Myriad X VPU processor. Another example of a neural computational model includes a Google Coral Edge TPU USB accelerator, which comprises an on-board Edge TPU coprocessor capable of performing 4 trillion operations (tera-operations) per second (TOPS), using 0.5 watts for each TOPS (2 TOPS per watt). The AI can interface with libraries of trained models object detection modules and optimized computer vision algorithms.

At block 118, the rules engine 128 of the object detection engine 124 can be configured to prioritize object detection analysis as between the respective camera 102a, 102b, 102c streams and object detection. For example, in the implementation described above, the rules engine can be configured to prioritize analysis from the backdoor camera 102c over the indoor camera 102b and the front door camera 102a in the afternoon and early evening, but prioritizes the indoor camera 102b over the backdoor camera 102c and the backdoor camera 102c over the front door camera 102a in the late night.

In an embodiment, the rules engine 128 is configured with rules for object detection. In at least one of the various embodiments, rules engine 128 can be arranged to use one or more filters, tests, rules, regular expressions, pattern matches, heuristics, or the like, for mapping the object detection to actions and/or views. In some embodiments, the rules engine can be arranged to determine the particular, filters, tests, rules, regular expressions, pattern matches, lookup tables, heuristics, or the like, for mapping detected objects to the object detection models. For example, the computer can be configured to employ a particular set of filters and rules for mapping detected objects from a particular camera stream.

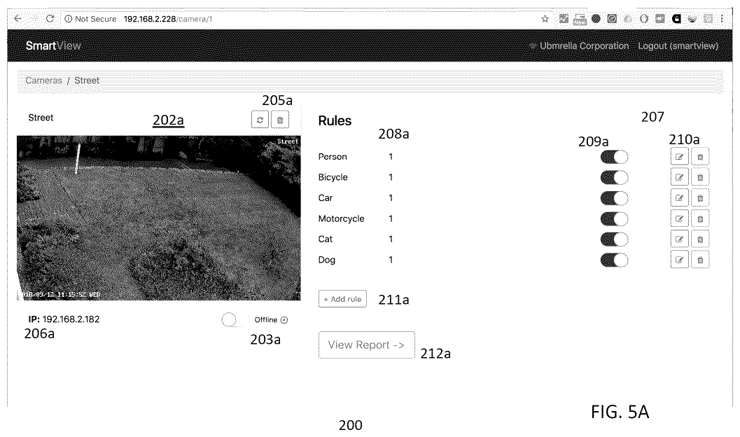

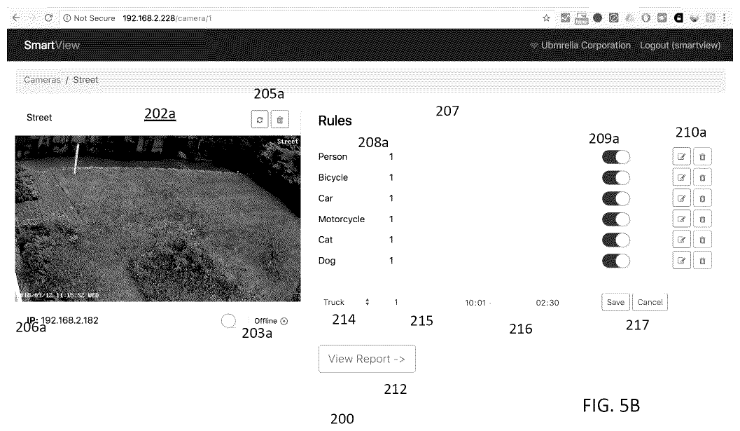

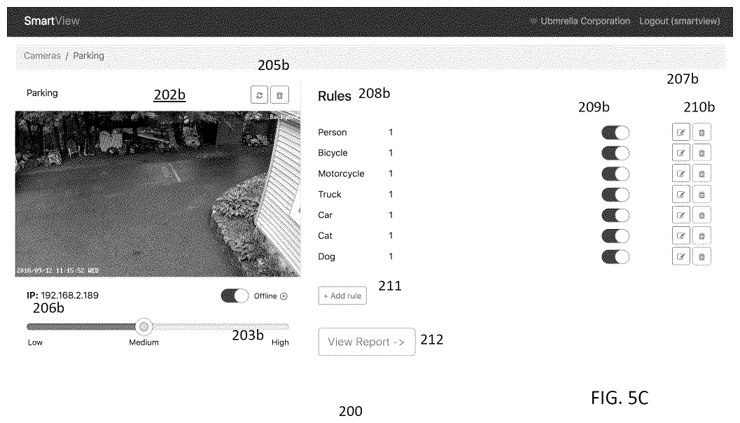

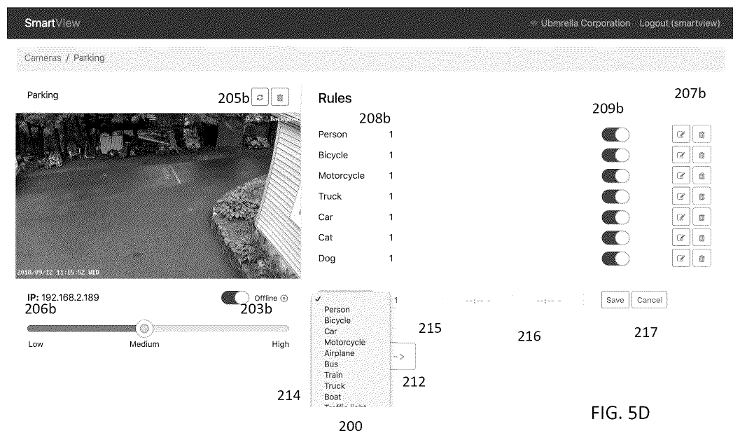

For example, in an embodiment, the system can be configured to allow the user to restrict or exclude detection objects identified by the object detection engine 124 for each camera stream. The rules engine 128 can be configured to ignore the objects detectable by the system unless it detects a threshold number of objects. The system can be configured to ignore the objects detectable by the system within a given time frame. For example, when the object detection analysis 118 detects a person, the rules engine 128 could be configured to take no further action unless more than one person is in the feed within a given time frame. (e.g. not to alert a user or save scenes from a feed). The system can be configured to allow the user to configure rules, for example with an administrative engine 120 using a dashboard display 133. An exemplary interface is described with respect to FIGS. 5A-5E.

In an embodiment, the system can be configured to define inclusion zones and exclusion zone. For example, the user can define and select a zone from a camera feed to monitor or ignore using a dashboard display 133 interface. The system can be configured to allow the user to draw a zone for inclusion or exclusion using the dashboard display, for example as described with respect to FIG. 5E, by using a draw tool 220 to draw a bounding box 219 that defines an inclusion zone 218. The system can then be configured to perform object detection for the inside the inclusion zone 218 defined by the user. The system can be configured to ignore objects outside the zone, and only perform frame analysis and object detection inside the bounding box 219.

As will be appreciated, other tools for defining exclusion zones and inclusion zones can be employed. For example, the system can be configured to analyze a feed and identify areas for inclusion zones 218 and exclusion zones 221. The system can be configured to then offer the user the ability to select or not select the areas or object detection analysis. For example, the system can detect that a large portion of a frame is, for example, a wooded area or a highway outside a parking lot being monitored. The system could then offer the user the opportunity to exclude the zone, for example, via the rule interface 207 shown in FIGS. 5A-E.

If the object detection analysis 118 meets a rule criterion, a device 101 notification engine 129 can be configured to deliver an alert to a user, for example, via an SMS message, and email, a chatbot 111 or other messaging interface. For example, if a rule for a camera 102a stream ignores 3 dogs from 6:00:00 am to 10:00:00 pm, but detects dogs between 10:00:01 pm to 5:59:59 am, the notification engine 129 can be configured to send an alert when a dog is detected between 10:00:01 pm to 5:59:59 am.

In an embodiment, the device 101 can be configured to monitor itself to identify performance bottlenecks and fine-tune the algorithm. If a hardware (or environment problem is detected (e.g.: the device is getting too hot), the device can be configured to notify the user automatically. In an embodiment, a watchdog service 115 or other customer service can interface with the client device 104, for example via a chatbot 111.

In at least one of the various embodiments, camera stream information from object detection component 124 can flow to report generator 131 and/or Notification engine 129. In at least one of the various embodiments, report generator 129 can be arranged to generate one or more reports based on the object detection analysis 118. In at least one of the various embodiments, reports can include analyzed frames from each camera stream as well as object detection information. In at least one of the various embodiments, reports can be determined and formatted based on one or more report templates.

In an implementation, a the I/O Network Relay 150 is configured to interface with an interface module, for example, security module user interface. The I/O Network relay 150 is configured to allow a user to integrate the device 101 with any electrical devices and appliances to trigger detection-driven actions, such as, for example, to turn on the lights, switch on alarm, open/close gates, lock/unlock doors, etc. The I/O Network Relay 150 can also interface and integrate with other security or perimeter protection systems, such as various alarm systems, so that a user can arm or disarm a security device such as a proactive video alarm from a conventional alarm panel. The I/O Network Relay 150 is configured to transform conventional household, office, or workplace appliances into a unified, complex security system that can both warn an owner of an intrusion as well as actively deter intruders and compel them retreat before they even approach a perimeter protected by the alarm itself.

As shown above with respect to FIGS. 1A-1C, inputs of the I/O Network Relay 150 are designed and configured to be universal so that they can be readily and easily integrated with virtually any alarm panel 156. The electromagnetic relays 152n inputs are each initiated with a dry contact, so a user can arm the system or disarm it by simply connecting or disconnecting both contacts with a mechanical switch—as simple as a paper clip—to switch the state of the system. A plurality of outputs of the relay—3 for example—have a voltage between 90V to 240V, which covers the most widespread range of devices. Each channel can power circuits up to 2500 W. No additional voltage needed for such an input.

A plurality of outputs of the relay—3 for example—have a voltage between 90V and 240V, which covers the most widespread range of devices. Each channel can power circuits up to 2500 W.

The I/O Relay can be configured an access point to allow setup and firmware updates. Then I/O Relay can be configured to operate as client for regular operation. In a client mode configuration, the I/O Relay can be configured to operate locally

The I/O Relay features can be combined to create a sequence of events that will in most cases create an impression of the owners being present inside the house to deter burglars from breaking in.

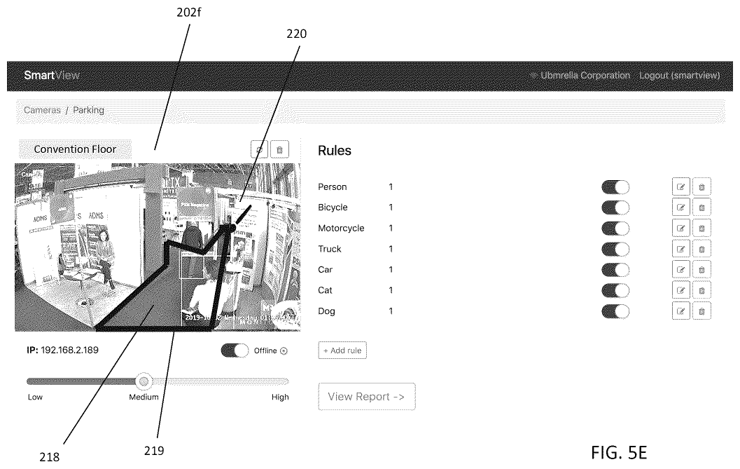

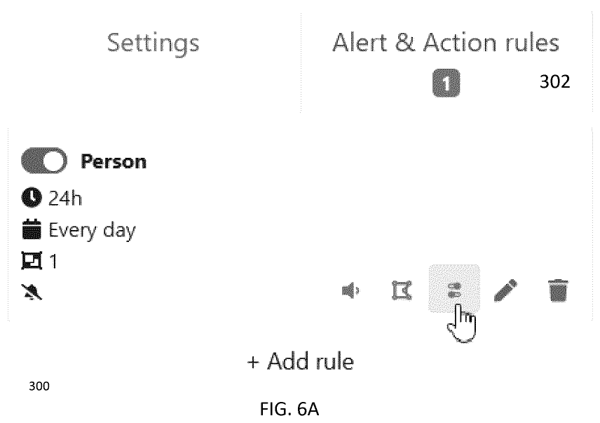

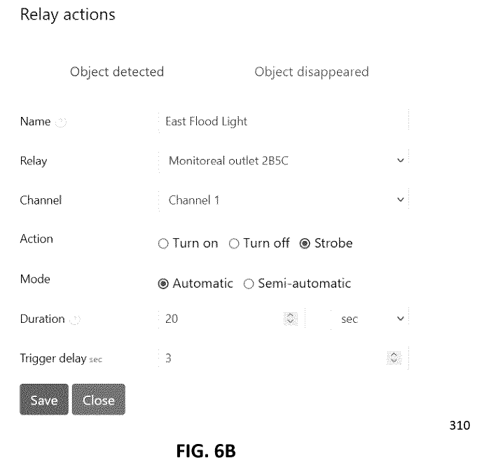

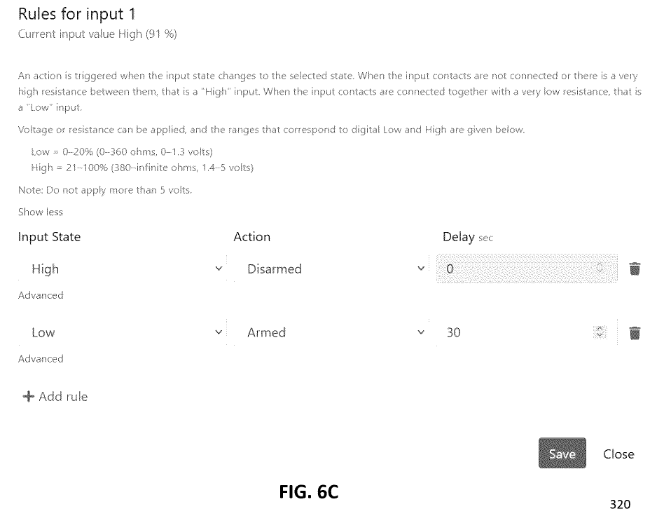

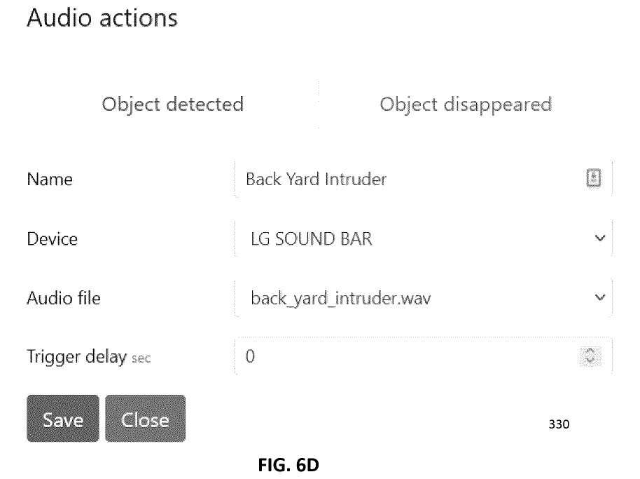

In an exemplary implementation, the I/O Relay 150 can be configured to interface with the device interface to configure relay actions. An exemplary implementation is shown with respect to FIGS. 6A-6B, below.

In an implementation, the I/O Relay 152 has three relays (outputs) and three inputs. Any of the inputs can be used to arm and disarm a security device such as an alarm system 156. In implementation, FIG. 6C shows an interface 320 that can be configured add rule(s) for an input state that will arm or disarm a security device. This allows for integration with alarm systems that have an output indicating an arming status, and it synchronizes the arming and disarming of the security device with an existing alarm system. A simple switch could also be connected to an input to provide a convenient way to arm and disarm user device. For example a switch or arming signal can be connected to an I/O device input. As noted herein, the input can be a dry contact switch or relay. An add rule interface can be configured to add rule(s) for an input state that will arm or disarm the security device. For example, as shown in FIG. 6C, the interface can be configured to allow a user to add two rules so that the security device can be armed and disarmed by the input. The rule can be configured to select High for one Input State, a Low for the other Input State, and then set the desired action for each state. The action can be triggered when the input state changes to the corresponding state. For instance, when the input contacts are not connected or there is a very high resistance between them, that is a “High” input. When the input contacts are connected together with a very low resistance (e.g., a wire), that is a “Low” input. For example, if you are using a voltage-free switch, then the input will be Low when the switch is closed, and High when the switch is open. In another example, some alarm panels provide an output with a voltage in the Low range for the user device when an alarm panel is armed, and an open circuit when disarmed. The low voltage corresponds to a closed switch and the open circuit is the same as an open switch. Optionally, an arming action may be delayed by a number of seconds. This can give additional time to clear a view of the cameras so not to trip the alarm while leaving just after arming the system.

In an implementation, an audio module allows a user to upload and play a sound file via a connected wireless speaker 155 (e.g. Bluetooth™) based on the rules they set. The rules can be set to be triggered when a specified object has been detected immediately or with delay. The device 101 also can include an input for uploading a sound file. Audio actions then be configured in a configuration interface for rules. For example, the device 101 can be configured to trigger the speaker to execute and play a sound file in response to object detection. An exemplary interface for an audio module is shown in FIG. 6D. For example, the interface 330 can be configured with an audio interface panel to connect a speaker to the network.

In at least one of the various embodiments, a dashboard display 133 interface can render a display of the information produced by the other components of the systems. In at least one of the various embodiments, dashboard display 133 can be presented on a client computer 102, 103 accessed over network.

Also, in at least one of the various embodiments, machine learning 132 analysis can include determining information from a record store, such as, training information database 130. Thus, in at least one of the various embodiments, training information database 130 can be a storehouse of stream and frame information that is associated with a camera feed 102. In at least one of the various embodiments, training information can be used to train on a machine learning engine 132 to and tune bespoke algorithms for each individual camera 102a . . . n to be employed by the scene detection engine 120 and the object detection engine 124. For example, in an embodiment, a machine learning engine 125 can comprise a neural net, which trains on analyzed feeds from the object detection engine 124 to determine how the object models determine what objects are detected and labeled, and tune decisioning for the object detection engine 124. The neural net can also train on analyzed feeds from the scene detection engine 120 to determine how the engine forwards feeds for further analysis and can tune decisioning for the scene detection engine 120.

For example, in an embodiment the device can implementing recognition of familiar faces (and other objects, for example, cars), automatically creating a set of previously seen object images that are clustered into groups (e.g. “all these look like one person”), to be further labeled by the user (“that person is my uncle Bob”). After that, the device can recognize the person or object.

In an embodiment, the system 100 can be configured to perform facial recognition. When an object is classified as an object of type “person”, the system can be configured to extract an area of the image that corresponds to the face. Facial recognition algorithms as configured to identify certain shapes in relation to each other (e.g.: eyes, nose, mouth) can be employed. The system can be configured to use, inter alia:
HAAR Cascades—very fast (12 frames per second), less accurate
HoG—slower (3 frames per second), more inaccurate
CNN—slowest (0.1 frames per second), most accurate

The system is then configured to cluster resulting faces together, based on whether or not they look like the same person. The user can then identify each cluster by labeling the images (e.g.: “Mom”, “Uncle Bob”).

Once labeled, the system 100 can identify specific individuals, and not just object types. After that, rules can be applied to labeled and recognized individuals as described herein (e.g. “alert me if there's a person after 10 pm, unless it's Uncle Bob”).

It will be understood that each block of the flowchart illustration, and combinations of blocks in the flowchart illustration, can be implemented by computer program instructions. These program instructions can be provided to a processor to produce a machine, such that the instructions, which execute on the processor, create means for implementing the actions specified in the flowchart block or blocks. The computer program instructions can be executed by a processor to cause a series of operational steps to be performed by the processor to produce a computer-implemented process such that the instructions, which execute on the processor to provide steps for implementing the actions specified in the flowchart block or blocks. The computer program instructions can also cause at least some of the operational steps shown in the blocks of the flowchart to be performed in parallel. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the invention.

FIG. 1A shows components of one embodiment of an environment in which embodiments of the innovations described herein can be practiced. Not all of the components can be required to practice the innovations, and variations in the arrangement and type of the components can be made without departing from the spirit or scope of the innovations. As shown, system 100 of FIG. 1 includes local area networks (LANs)/wide area networks (WANs)—(network) 110, wired and/or wireless network 103, cameras 102a-102c and computers 101, 104-106.

The embodiments disclosed herein can be practiced using programmable digital computers. A computer or computer device includes at least one processor or microprocessor coupled to a communications channel. The computer further includes an input device such as, e.g., a keyboard or mouse, an output device such as, e.g., a CRT, LCD or LED display, a communications interface, a data storage device such as a magnetic disk or an optical disk, and memory such as Random-Access Memory (RAM), each coupled to the communications channel. The communications interface can be coupled to a network 103/110.

A data storage device and/or memory can store an operating system. Other programs can be stored instead of or in addition to the operating system. It will be appreciated that a computer system can also be implemented on platforms and operating systems other than those mentioned. Any operating system or other program, or any part of either, can be written using one or more programming languages such as, e.g., Java®, C, C++, C #, Visual Basic®, VB.NET®, Perl, Ruby, Python, or other programming languages, possibly using object-oriented design and/or coding techniques.

One skilled in the art will recognize that a computer system can also include additional components and/or systems, such as network connections, additional memory, additional processors, network interfaces, input/output busses, for example. One skilled in the art will also recognize that the programs and data can be received by and stored in the system in alternative ways. For example, a computer-readable storage medium (CRSM) reader, such as, e.g., a magnetic disk drive, magneto-optical drive, optical disk drive, or flash drive, can be coupled to the communications bus for reading from a computer-readable storage medium (CRSM) such as, e.g., a magnetic disk, a magneto-optical disk, an optical disk, or flash RAM. Accordingly, the computer system can receive programs and/or data via the CRSM reader. Further, it will be appreciated that the term “memory” herein is intended to include various types of suitable data storage media, whether permanent or temporary, including among other things the data storage device, the memory, and the CSRM.

In one embodiment, at least some of computers 101, 104-106 can operate over a wired and/or wireless network, such as networks 103 and/or 110. Cameras 102a-102c can also be computers, although as will be appreciated, the cameras can be any camera device capable of providing a video stream to a device 101 for processing as described herein. Generally, computers can include virtually any computer capable of communicating over a network to send and receive information, perform various online activities, offline actions, or the like. In one embodiment, one or more of computers 101, 102, 104-106 can be configured to operate within a business or other entity to perform a variety of services for the business or other entity. For example, computers 101, 102, 104, 105, 106 can be configured to operate as a web server, a media and video streaming server, a smart camera, administrative computer, or the like. However, computers 101, 102 and 104-106 are not constrained to these services and can also be employed, for example, as an end-user computing node, in other embodiments. It should be recognized that more or less computers can be included within a system such as described herein, and embodiments are therefore not constrained by the number or type of client computers employed.

Computers, including cameras, can include computers that typically connect using a wired or wireless communications medium such as personal computers, multiprocessor systems, microprocessor-based or programmable electronic devices, network PCs, or the like. In some embodiments, computers 101, 102-106 can include virtually any portable personal computer 104, 106 or camera 102 capable of connecting to another computing device and receiving information such as, laptop computer, smart mobile telephone, and tablet computers, and the like. However, portable computers 102, 104, 106 are not so limited and can also include other portable devices such as cellular telephones, display pagers, radio frequency (RF) devices, infrared (IR) devices, Personal Digital Assistants (PDAs), smart cameras, handheld computers, wearable computers, integrated devices combining one or more of the preceding devices, and the like. As such, client computers 101, 102, and 104-106 typically range widely in terms of capabilities and features. Moreover, computers 101, 102 and 104-106 can access various computing applications, including a browser, or other web-based application.

A web-enabled computer can include a browser application that is configured to receive and to send web pages, web-based messages, and the like. The browser application can be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), JSON (JavaScript Object Notation), and the like, to display and send a message. In one embodiment, a user of the client computer can employ the browser application to perform various activities over a network (online). However, another application can also be used to perform various online activities.

Computers 101, 102 and 104-106 can also include at least one other application that is configured to receive and/or send content between another computer. The application can include a capability to send and/or receive content, or the like. The application can further provide information that identifies itself, including a type, capability, name, and the like. In one embodiment, client computers 101, 102 and 104-106 can uniquely identify themselves through any of a variety of mechanisms, including an Internet Protocol (IP) address, a phone number, Mobile Identification Number (MIN), an electronic serial number (ESN), or other device identifier. Such information can be provided in a network packet, or the like, sent between other computers.

Computers can further be configured to include a client application that enables an end-user to log into an end-user account that can be managed by another computer, such as a Server Computer 105, Watchdog Server Computer 115, Administrative Computer 106 or the like. Such end-user account, in one non-limiting example, can be configured to enable the end-user to manage one or more online activities, including in one non-limiting example, search activities, social networking activities, browse various websites, communicate with other users, or the like. However, participation in such online activities can also be performed without logging into the end-user account.

Wireless network 103 is configured to couple computers and its components with network 110. Wireless network 103 can include any of a variety of wireless sub-networks that can further overlay stand-alone ad-hoc networks, and the like, to provide an infrastructure-oriented connection for computers. Such sub-networks can include mesh networks, Wireless LAN (WLAN) networks, cellular networks, and the like. In one embodiment, the system can include more than one wireless network.

Wireless network 103 can further include an autonomous system of terminals, gateways, routers, and the like connected by wireless radio links, and the like. In an implementation, wireless network can include a I/O network relay 150, discussed in more detail herein. These connectors can be configured to move freely and randomly and organize themselves arbitrarily, such that the topology of wireless network 108 can change rapidly.

Wireless network 103 can further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks can enable wide area coverage for mobile devices, such as client computers and cameras with various degrees of mobility. In one non-limiting example, wireless network 103 can enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 103 can include virtually any wireless communication mechanism by which information can travel between client computers and another computer, network, and the like.

Computers can optionally communicate directly with another computer. A network interface can include circuitry for coupling to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra wide band (UWB), IEEE 802.16 Worldwide Interoperability for Microwave Access (WiMax), session initiated protocol/real-time transport protocol (SIP/RTP), or any of a variety of other wireless communication protocols.

Network 110 is configured to couple computers with other computers and/or computing devices, including, Server Computer 105, and Video Server Computer 102c, administrative computer 106, client computer 104, computer 101, and client computers/cameras 102a-102b, relay 150, speakers 155, building security devices 156 and utilities such as alarm control panels, and electrical appliances 157, for example lighting 153, speakers 155, smart devices through wireless network 103. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks can utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links can further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 can be configured to transport information of an Internet Protocol (IP). In essence, network 110 includes any communication method by which information can travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

Blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments.

### Illustrative User Interface Use Cases

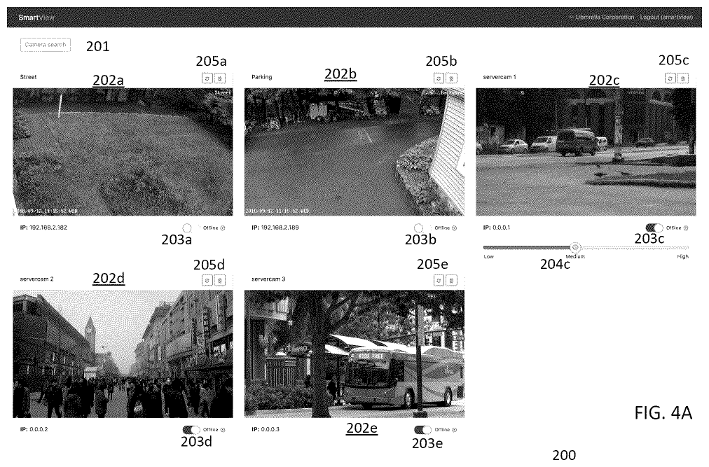

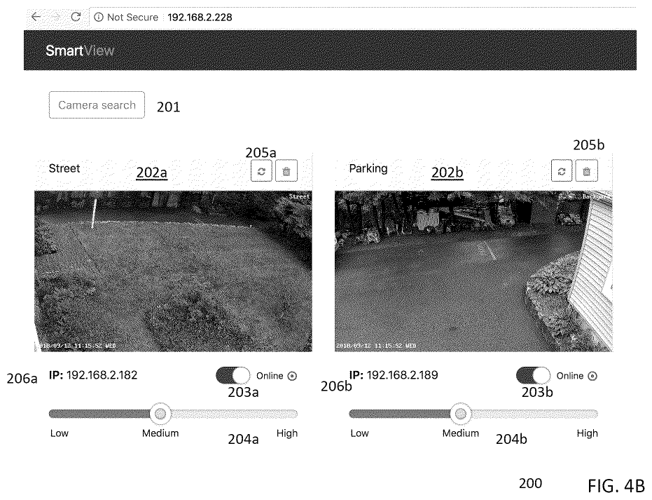

FIGS. 4A-7E represent graphical user interfaces for at least one of the various embodiments. In at least one of the various embodiments, user interfaces other than user interfaces 200, 300 as shown in FIG. 4A-7E can be employed without departing from the spirit and/or scope of the present disclosure. Such user interfaces can have more or fewer user interface elements which can be arranged in various ways. In some embodiments, user interfaces can be generated using web pages, mobile applications, or the like. In at least one of the various embodiments, the system can include processes and/or API's for generating user interfaces, such as, user interfaces 200, 300 as shown in FIG. 4A-7E.

In an embodiment, FIG. 4A illustrates a graphical user interface with five camera feeds 202a, 202b, 202c, 202d, 202e. The interface includes a search interface object 201 configured to allow the computer device to search for and detect camera hardware and connect the camera 202 to the device over the network. Each camera feed is from a different camera 102a-102n, providing streams to the computer device 101. As shown in FIG. 4A feed 202a is a Street feed, 202b is a Parking feed, and cameras 202c-202e are feeds from cameras being provided from servers in remote locations. Each camera feed 202a-202e is provided with control interface objects, including a control 205a-205c to refresh or delete the feed from the interface panel 200 and a control to view the stream online or offline 203a-203e. The feed 202c can also include an object detection sensitivity adjuster 204c configured to adjust the detection sensitivity of the stream analysis.

As shown in FIG. 4B, the control interface objects 205c-205e allow the server feeds 202c-202e to be removed from the interface panel, leaving the Street feed 202a and the Parking feed 202b.

In an embodiment, interface 200 is configured allow the user to configure rules for each camera feed 202a-202b. As shown in FIG. 5A, the interface 200 include a rule interface 207, which includes selected rules 208a for monitoring the camera feed 202a, a rule activation interface object 209a for activating or deactivating the rule, and an edit or delete interface object 210 for editing or deleting the rule. The rule interface 207 also includes an Add Rule object 211a for adding one or more new rules to the rule interface 207 for that camera feed 202a. The interface 200 for the selected camera feed 202a also includes a View Report 212a object for generating a monitoring report for camera feed 202a.

In the example shown in FIG. 5A, the rule interface 207 shows the Street camera feed 202b has been configured to ignore a person, bicycle, car, motorcycle, a cat, and a dog if only one (1) of these are detected. The activation interface object 209, a toggle switch, shows the rule is active. As explained herein, each rule can be configured to be operative in a given time range.

As shown in FIG. 5B, the Add Rule object 211a of the rule interface 207 for adding new rules to the rule interface 207 includes a rule configuration area including an object selection field 214, a number field 215, a time range field 216, and a save or cancel interface object 217. In an embodiment, the object selection field 214 can be configured with a drop-down menu including a list of objects that the system 100 can detect, for example from the object detection modules. For example, as shown in FIG. 5D, the drop-down menu includes a Person, Bicycle, Car, Motorcycle, Airplane, Bus, Train, Boat, Traffic Light, and can be scrolled or keyed for more options. In an embodiment, the system 100 can be configured with lists of objects configured for common camera views. For example, the system 100 could be further configured to present sets of objects known or learned (e.g. via machine learning) to be associated with a parking lot, a street view, or a main entrance of a particular business or class of businesses (e.g. doctor's office, a market).

The number field 215 allows the user to select a number for the object selected for which the object detection 118 will “ignore”—that is, it will not send an alert or start active monitoring and tracking. The time range field 216 includes input interfaces for setting a begin and end time for which the rule is operative (e.g. 10:01 am-02:30 pm). Once the rule is configured, it can be saved to the rule interface 207 for that particular camera feed 202a or it can be cancelled using the save or cancel interface object 217.

FIG. 5E shows an exemplary embodiment of a system interface configured to define an inclusion zone and an exclusion zone for a camera feed, shown as a video feed for a convention floor. The interface is configured to allow a user to define an inclusion zone 218 for object detection in a monitored video feed 202f from a camera. The system can be configured to perform object detection for the inside the inclusion zone 218 defined by the user, for example by using a draw tool to draw a bounding box that defines an inclusion zone 218. The system 100 is configured to ignore objects outside the zone, and only perform frame analysis and object detection inside the bounding box 219. As will be appreciated, other tools for defining exclusion zones and inclusion zones can be employed. For example, the system 100 can be configured to analyze a feed and identify areas for inclusion zones and exclusion zones. The system 100 can be configured to then offer the user the ability to select or not select the areas or object detection analysis. For example, the system 100 can detect that a large portion of a frame is, for example, a wooded area or a highway outside a parking lot being monitored. The system 100 could then offer the user the opportunity to exclude the zone, for example via the rule interface 207.

In an embodiment, an interface 300 is configured allow the user to configure rules for an I/O Relay. As shown in FIG. 6A, the interface 300 includes a rule interface, which includes an object for adding the rule, and an edit or delete interface object for editing or deleting the rule. In an exemplary implementation, the I/O Relay 150 can be configured to interface with the device interface to configure relay actions. For example, as shown in FIG. 6A, an “Action & Alert Rules” 302 for each of camera feed 102n can be linked to the relay via the wireless or ethernet network connection 103. The interface can be configured to allow a user generate rules an identify a relay button for the rule that trigger the relay.

FIG. 6B shows an example of a Relay action configuration interface 310. The interface page includes fields to configure the device to trigger the I/O Relay to execute an action in response to object detection. An “Object detected” tab and/or “Object disappeared” allows the user to configure the device to operate an appliance when the system performs object detection. As shown in FIG. 6B, the system relay is connected to a floodlight on a first channel. The interface allows the user to name the device that the relay triggers. The interface then allows the user to select the relay by name and the channel that is connected to for device to be triggered. The interface then allows the user to select the desired relay action. For example, relay can be configured to employ the switch to turn the device on, turn the device off, or control the switch in an on/off pattern, for example, an option to strobe by slowly switching the relay on and off repeatedly for a specified duration. In an implementation, interface can be configured set the relay to an automatic mode, requiring no user input, or a semi-automatic mode, where the user is asked to confirm the relay action (e.g., via a messaging tool such as email, an SMS interface, a messaging network, and so on). For a strobe operation, the relay interface can be configured to allow a user to set the duration (e.g in seconds (sec) or milliseconds (ms)), after which the relay returns to its previous state after the duration. The interface can also include a trigger delay (e.g. 0 or more whole seconds), which can make the strobe effect seem more like a real human response.

In an implementation, FIG. 6C shows an example of an “add rule” interface can be configured add rule(s) for an input state that will arm or disarm the security device. As explained above, the exemplary interface 320 can be configured to allow a user to add two rules so that the security device can be armed and disarmed by the input. The rule can be configured to select High for one Input State, a Low for the other Input State, and then set the desired action for each state. The action can be triggered when the input state changes to the corresponding state.

FIG. 6D shows an exemplary implementation of an Audio Module interface 330. The audio module interface 330 is configured to allows a user to upload and play a sound file via a connected wireless speaker 155 (e.g., Bluetooth™) based on the rules they set. The rules can be set to be triggered when a specified object has been detected immediately or with delay. For example, the interface can be configured with an Audio interface 330 panel to connect a speaker to the network. The interface 330 also can include an input for uploading a sound file. Audio actions then be configured in action configuration. As shown in FIG. 6D, the interface page includes fields to configure the device to trigger the speaker to execute an action in response to object detection. An “Object detected” tab and/or “Object disappeared” allows the user to configure the device to play the sound file when the system performs object detection.

In implementations, rule interfaces for the I/O relay can be configured to control devices for more complex object detection. For example, the rules can be configured to operate appliances or devices based on object detection and labeling, inclusion and exclusion zones, or patterns learned from machine intelligence as described herein.

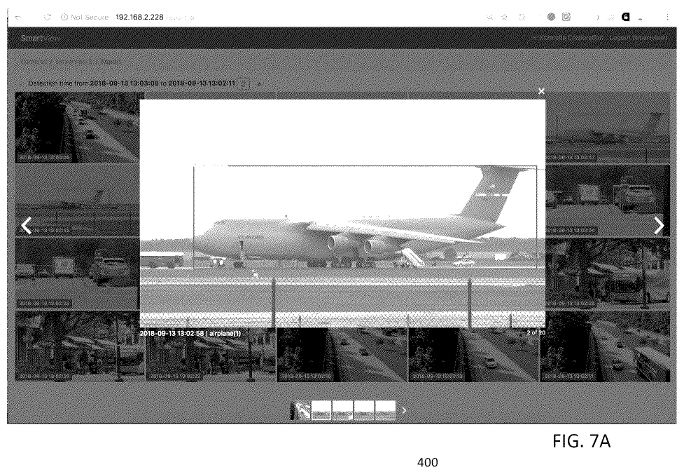

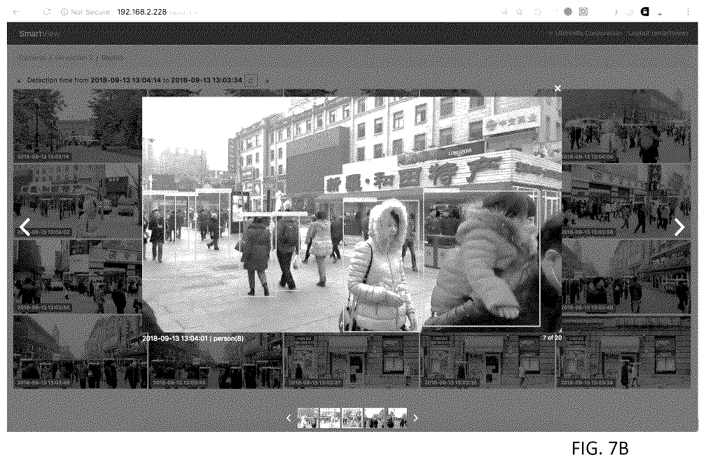

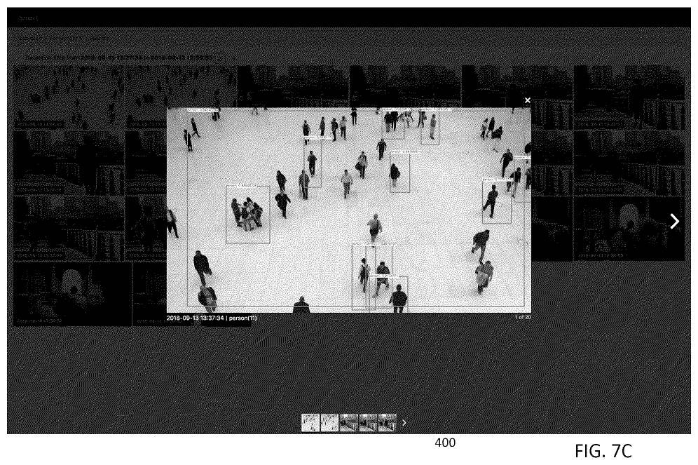

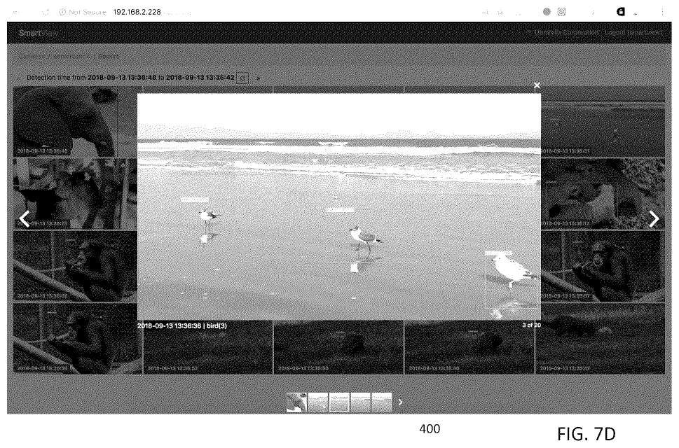

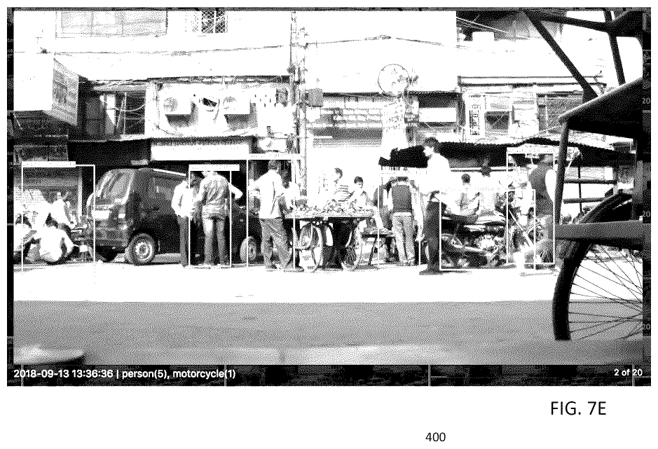

FIGS. 7A-7E, show examples of object detection in selected frames of a report interface 400. As shown in FIG. 7A, upon selecting a frame from the report, the display shows the selected frame stored from the feed and a tag of the object detected in the object detection frame. For example, FIG. 7A shows a single airplane was identified in the frame and the object detection frame labeled as an “airplane” by the object detection engine 124. The frame from the feed is tagged with the time and type and number of objects detected. As shown in FIG. 7A, the frame is tagged as 2018 Sep. 13 13:02:58| airplane (1). FIG. 7B shows that 8 persons were identified in the frame, and the object detection frames are labeled as “person” by the object detection engine 124. As shown in FIG. 7B, the frame is tagged as 2018Sep. 13 13:04:01| person (8). FIG. 7C shows 11 persons were identified in the frame, and the object detection frames are labeled as “person” by the object detection engine 124. As shown in FIG. 7C, the frame is tagged as 2018 Sep. 13 13:37:34| person (11). FIG. 7D shows that three birds were identified in the frame, and the object detection frames were labeled as “bird” by the object detection engine 124. As shown in FIG. 7D, the frame from the feed is tagged as 2018 Sep. 13 13:36:36| bird (3). FIG. 7E shows that 5 people and 1 motorcycle were identified in the frame. The 5 object detection frames were labeled as “person” and 1 object detection frame was labeled as “motorcycle” by the object detection engine 124. As shown in FIG. 7E, the frame from the feed is tagged as 2018 Sep. 13 13:36:36 | person (3), motorcycle (1).

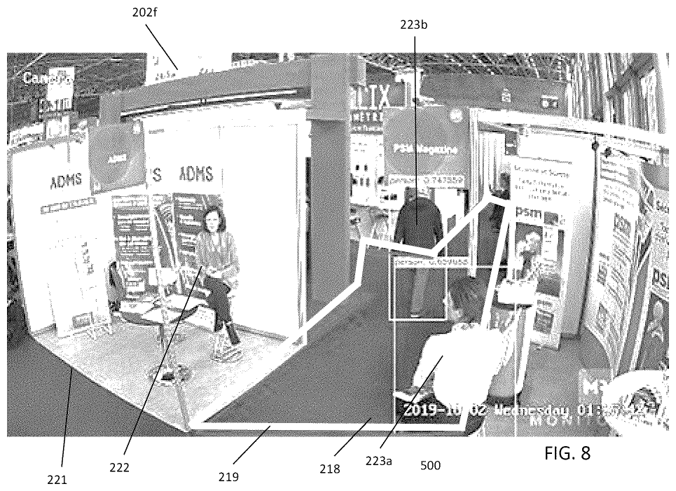

FIG. 8 shows an exemplary embodiment of an interface 500 for a video feed 202 having an inclusion zone 218 and an exclusion zone 221. As discussed with respect to FIG. 5E, the system 100 is configured to allow a user to define an inclusion zone 218 for object detection in a monitored video feed 202f of a conference floor from a camera. The system 100 is configured to perform object detection for the inside the inclusion zone 218 defined by the user. The system 100 is configured to ignore objects outside the zone, and only perform frame analysis and object detection inside the bounding box 219. As shown FIG. 8, the system 100 identifies 2 people 223a, 223b in the inclusion zone 218, which the object detection engine labels as “person”. However, the system 100 ignores the exclusion area 221 outside the bounding box 219, and thus does not identify or label, inter alia, the person 222 in the exclusion area.

The user interfaces 200, 300, 310, 320, 400, 500 have been described using the example of a dashboard suitable for a personal computer, as this is an amenable form for the purpose of explanation. Similar graphical user interfaces with a dashboard format can also be provided as a mobile app, e.g. for Android or iPhone operating systems, where the term “mobile app” refers primarily to a module of applications software capable of running on a smart phone or tablet device or other client computer. Other types of user interface can also be provided. An alternative user interface type is an application programming interface (API), which is the type of user interface which would be suitable for developers who wish to integrate the system as described herein with a third party software application, e.g. to incorporate outputs from the computer device in a flexible manner suited to the third party applications software which is being integrated.

1. A device comprising:
a computer that includes:
a transceiver for communicating over a network;
a memory for storing at least instructions;
a relay comprising a plurality of channels for controlling a plurality of electric appliances;
a processor device configured to operate the relay and for edge processing of one or more video streams and to perform object detection on a local network independent of a cloud architecture; and
an object detection engine configured to detect an object in the one or more video streams,
wherein the device is configured to operate the relay to control one or more electric appliances if the object detected by the object detection engine meets an object detection rule.

2. The device of claim 1, wherein the processor device is configured to monitor a plurality of the one or more video streams from a plurality of respective cameras.

3. The device of claim 1, further comprising:
a scene detection engine configured to perform scene analysis to determine if a scene from the one or more video streams meets an object detection threshold to pass the scene to the object detection engine.

4. The device of claim 1, wherein the relay comprises:
an interface configured to integrate the device with the one or more electric appliances.

5. The device of claim 4, wherein the interface comprises a security module user interface, and the plurality of electric appliances includes a security device.

6. The device of claim 5, wherein the security device comprises an alarm, a light, or both.

7. The device of claim 1, wherein the relay comprises a plurality of electromagnetic relay inputs.

8. The device of claim 1, wherein the plurality of electromagnetic relay inputs comprises a dry contact.

9. The device of claim 1, wherein the relay comprises plurality of outputs.

10. The device of claim 9, wherein the plurality of outputs are from 90V to 240V.

11. The device of claim 1, wherein the processor is configured operate the relay to control the one or more electrical appliances to run a sequence of operations to give the appearance of someone being present at a building.

12. The device of claim 4, the interface further comprising:
a rule interface configured with one or more rules to operate the relay to control the one or more electric appliances.

13. The device of claim 12, further comprising:
the rule interface being configured to allow a user to add one or more rules to operate the relay to control the one or more electric appliances.

14. The device of claim 12, further comprising:
the rule interface being configured to allow a user to identify a specific electrical appliance of the one or more electrical appliances and a channel of the relay the specific electrical appliance is on.

15. The device of claim 4, wherein the interface includes a page that includes a field to configure the device to trigger the relay to execute an action in response to the object detection.

16. The device of claim 4, wherein the device comprises:
an audio module interface configured to play a sound file on a connected speaker when the object detected by the object detection engine meets the object detection rule.

17. The device of claim 16, wherein the device comprises:
the audio module interface being configured to allow a user to upload an audio file to be played when the object detected by the object detection engine meets an object detection rule.

18. The device of claim 1, wherein the relay comprises a switch, and the device configured to employ the switch to turn the device on, turn the device off, or control the switch in an on/off pattern.

19. A computer program product for a device comprising a computer that includes:
a transceiver for communicating over a network;
a memory for storing at least program instructions in program memory;
a relay comprising a plurality of channels for controlling a plurality of electric appliances;
a processor device configured to execute the instructions operate the relay and for edge processing of one or more video streams and to perform object detection on a local network independent of a cloud architecture; and
an object detection engine configured to detect an object in the one or more video streams,
wherein the device is configured to operate the relay to control one or more of the electric appliances if the object detected by the object detection engine meets an object detection rule.

20. A method for a computer that includes:
a transceiver for communicating over a network;
a memory for storing at least program instructions for the method;
a relay comprising a plurality of channels for controlling a plurality of electric appliances;
a processor device configured execute the instructions to operate the relay and for edge processing of one or more video streams and to perform object detection on a local network independent of a cloud architecture; and
an object detection engine configured to detect an object in the one or more video streams,
wherein the method comprises:
configuring the relay to control one or more electric appliances if the object detected by the object detection engine meets an object detection rule.
